(19) United States
(12) Patent Application Publication
(10) Pub. No.: US 2017/0341987 A1
(43) Pub. Date: Nov. 30, 2017

(54) Foaming Agent for Building Material/Binder Pastes

(71) Applicant: CellConTec GmbH, Wolfsburg (DE)

(72) Inventor: Guenzel Graf Von Der Schulenburg, Wolfsburg (DE)

(21) Appl. No.: 15/603,968

(22) Filed: May 24, 2017

(30) Foreign Application Priority Data
May 25, 2016 (DE) 102016109751.9

(51) Int. Cl. C04B 38/10; C04B 40/00; C04B 28/14; C04B 28/02; C04B 103/40; C04B 103/42; C04B 111/40

(52) U.S. Cl. CPC C04B 38/10; C04B 28/14; C04B 40/0039; C04B 28/02; C04B 2103/42; C04B 2111/40; C04B 2103/40

(57) ABSTRACT

A foaming agent, more particularly for the foaming of a building material/binder paste for producing pory lightweight-construction and insulating materials, is improved in terms of its stability and usefulness at relatively low outdoor temperatures. The foaming agent in the form of an aqueous-organic solution comprises or consists to an extent of at least 85 wt % of the following constituents: a) a surfactant component which comprises at least one foam-forming ionic surfactant, b) a fatty alcohol component which comprises at least one fatty alcohol and at least one ethoxylated fatty alcohol in a FA/FAEO mixing ratio of 95:5 to 0:100, c) a glycol component which comprises at least one constituent of the group of alkyl glycols, alkylene glycols up to C6 alkyl, diglycols, especially alkyl diglycols and diglycol ethers, and water.

### FIELD OF THE INVENTION

The invention relates to a foaming agent, more particularly for the foaming of a building material/binder paste for producing pory (porous) lightweight-construction and insulating materials. The building material foams produced, these being foamed building material pastes, set while very largely retaining the pore structure, optionally after addition of aggregates, and form porous lightweight-construction and insulating materials which are installed on site, or form shaped products, such as blocks, slabs, and other moldings.

### BACKGROUND

Generic building-material foaming agents are essentially “soap solutions”, which are used in the foaming of the building material pastes and which in terms of composition are formulated such that they disperse effectively and uniformly within the building material paste or a precursor thereof, with additives in the soap or surfactant solution serving for purposes including stabilization of the foam before setting, as extensively as possible and under any of a wide variety of different conditions (such as temperatures, conveying conditions, pressure conditions).

In general the binder paste, which occasionally, and especially if mixed with aggregates, is also referred to as binder slurry, is mixed with a foam produced separately from a foaming agent and water, to give a material interspersed with air bubbles.

The building materials to be foamed are, in particular, hydraulically setting building materials, whose strength is provided by binders and is reinforced or tailored by means of additives and aggregates.

The building materials for the purposes of this description may be gypsum, concrete, lime or mixed forms thereof. The binders encompass slaked lime, gypsum in the form of natural gypsum and FGD gypsum, and a wide variety of different types of cement, preferably Portland cement or high-alumina cements. The designation of the gypsum, lime and cement binders customarily also includes those binders which in minor amount include a different binder or other, additional mineral constituents in powder form, examples being inorganic oxides (Mg, Si, Fe).

From binder and water (mixing water or added water), a binder paste is produced. Constituents of the binder react with the water and, in so doing, they set. In some cases this produces the building material directly, as in the case of filling plaster and certain lime renders, for example. In other cases an aggregate, usually gravel, sand, ash or slag, is admixed to the binder paste. It is possible for additives, here also called construction chemical admixtures, to be added in order to give the building material particular desired properties or to provide more strength. All of these mixtures made up with water are summarized here by the term “binder paste”.

The objective is for the building material paste mass foamed with the foaming agent to set with retention of the pore structure. Prolonged standing times, conveying of the material to the site of use, temperature effects, and other factors frequently accelerate the breakdown of the pore structure in such a way that a satisfactory outcome cannot be achieved.

U.S. Pat. No. 4,678,515 A (Green) discloses a method for producing a plasterboard panel having a plaster core which is foamed before curing. The foaming agent comprises sodium salts and/or ammonium salts of n-alkyl-ethoxylated sulfuric acids, or salts of the mono-sulfuric esters of ethoxylated fatty alcohols, of formula CH₃(CH₂)ₓCH₂(OCH₂CH₂)_{y}OSO₃⁻M⁺ with x=6 to 12 and y=1 to 3.5, a mixture of differently ethoxylated esters being proposed. The foams produced therefrom are said to exhibit relatively high foam volume and good stability.

U.S. Pat. No. 4,156,615 (Cukier) describes a very similar plasterboard panel, in which a plaster-of-Paris suspension is produced using a separately produced foam from surfactants corresponding in terms of formula to the “Green” disclosure. The advantage here, however, is said to be that hydration is accelerated and the panel sets more rapidly.

A disadvantage of the foams known from the prior art is that they are not sufficiently conveyable, in other words, for example, they collapse when being injected into the cavities to be insulated, and that the same formulas can in general not be used both at room temperature and at relatively high and relatively low temperatures. Constituents precipitate from certain known foaming agents at temperatures below 10° C., meaning that the foaming agents have to be heated and re-homogenized on the building site before being used. This is impracticable.

### SUMMARY

An object of the invention is to provide an improved foaming agent, especially for building material foams formed from hydraulically setting building material pastes, that avoids disadvantages from the prior art.

Provided as a solution to this object is a foaming agent as described herein. With the aid of this foaming agent it is possible to produce a foamed building material paste which can be used on building sites, among other locations, and especially in road building, as a lightweight insulating and lining material that is produced and installed in situ.

In an embodiment, the foaming agent is in the form of an aqueous-organic solution concentrate which comprises or consists to an extent of at least 85 wt % of the following constituents: a) a surfactant component which comprises at least one foam-forming ionic surfactant, b) a fatty alcohol component which comprises at least one fatty alcohol and at least one ethoxylated fatty alcohol in a FA/FAEO mixing ratio of 95:5 to 0:100, c) a glycol component which comprises at least one constituent of the group of alkyl glycols, alkylene glycols up to C6 alkyl, diglycols, especially alkyl diglycols and diglycol ethers, and water. In the concentrate the organic substances, i.e., FA, FAEO, glycols, and surfactant (e.g., SDS) amount to at least 85 wt % while the water content is less than 25 wt %. The concentrate can be freeze dried or further diluted with water (e.g., up to 25 times its initial volume).

### DETAILED DESCRIPTION

It has been found that the foaming agent of the invention is also suitable for producing foams which have other possible uses. A foam produced with the foaming agent and water and also, optionally, further additives can be used, for example, as a foam extinguisher. It is also possible for other compositions to be foamed as building material pastes, examples being solutions and suspensions for other materials. By setting or drying of such further compositions, porous materials for a wide variety of different fields are formed.

According to one preferred aspect of the invention, lightweight porous construction products are obtainable by means of the foaming agent, more particularly construction elements which can for example be cast or sprayed. Such construction elements encompass, preferably, slabs, shaped blocks, and composite panels with other materials, examples being plasterboard panels.

The foaming agent according to the invention includes fundamentally three basic components: a) the surfactant component, b) the fatty alcohol component, and c) the glycol component. The surfactant or the surfactants of the surfactant component are customarily held or purchased as (e.g., 1-4%) aqueous solutions and are mixed in suitable quantity with the remaining organic constituents of the composition. Further water may be added. The result is a surfactant-type foaming agent in aqueous-organic solution, i.e., in a solution comprising water and water-miscible organic solvents, or water-miscible organic-chemical compounds, which can be interpreted as organic solvents, solubilizers, etc.

The basic composition designated above accounts for at least 80 wt % of the foaming agent, preferably at least 90 wt %. Further constituents tolerated by the foaming agent—to give a homogeneous mixture and the desired activity—include additional alcohols which are fully miscible, and preferably miscible in any proportion, with water, examples being n-alkyl and isoalkyl alcohols, e.g., ethanol or butanol.

In the preferred embodiments, the surfactant component a) comprises exclusively anionic surfactants.

Suitable surfactants are, in principle, highly foaming, alkali-stable or even alkalinically reacting surfactants. The primary factor here is a high foaming power. Preference is given to sulfonates, alkyl sulfates, more particularly alkali metal alkyl sulfates, alkylene sulfates or alkyl ether sulfates. The alkyl chains or alkylene chains of the sulfonates and sulfates are preferably long-chain and more preferably are unbranched. Chain lengths greater than or equal to C8 and preferably between C10 and C18 may be considered to be typical.

Preferred surfactants encompass, among others, linear alkylsulfonates, alpha olefinsulfonates and beta olefinsulfonates, alkali metal salts and ammonium salts of monoesters of sulfuric acid having alkyl radicals from C6 onward, and also the monosulfuric esters themselves. Presently preferred are alpha olefinsulfonates, e.g., sodium C12-14 olefin-sulfonate and, among the alkyl sulfates, SDS and SLS.

Other anionic surfactants which can be used are those which are available commercially and in substantial quantity—that is, not just as fine chemicals on the laboratory scale—as foaming anionic surfactants. These include succinates, long-chain carboxylic acids and salts thereof, ethercarboxylic and estercarboxylic acids, and so on.

An individual surfactant or a mixture of two or more surfactants may be used. The surfactant content in the foaming agent is preferably at least 0.5 wt % (solids content), based on 100 wt % of the foaming agent overall, but may also be significantly higher. This can be set by the skilled person themselves, within the bounds of customary skilled-person ability. Suitable concentrations are fundamentally no different from those which are already known and in use for corresponding agents in the prior art.

The fatty alcohol component b) preferably includes or consists of at least one fatty alcohol and at least one ethoxylated fatty alcohol, in a FA/FAEO mixing ratio of 95:5 to 0:100. The fatty alcohol (FA) known as a support agent, which gives the foam more stability and a longer service life, is therefore replaced wholly or partly, in accordance with the invention, by ethoxylated fatty alcohols (FAEO).

Preferred quantitative ratios of FA/FAEO are 30:70 to 70:30, more preferably 40:60 to 60:40, and very preferably 50:50 to 30:70.

The fatty alcohols preferably possess a chain length of 6 to 20 carbon atoms. The ethoxylated fatty alcohols preferably possess, likewise, fatty alcohol residues having 6 to 20 carbon atoms and a degree of ethoxylation of on average at least 6 EO units per molecule, and, starting from a C8 fatty alcohol chain, more preferably at least 10 EO units per molecule. The ethoxylated fatty alcohol preferably possesses on average at least as many EO units, or more, as there are carbon atoms in the FA chain, or, in the case of mixed ethoxylated fatty alcohols, in the average length of the FA chain.

With particular preference the degree of ethoxylation is up to twice the length of the FA alkyl radical +6, but at least on average at least 6 EO units per molecule and, from a C8 FA chain length onward, preferably at least 10 EO units per molecule. Accordingly, for example, a particularly preferred degree of ethoxylation for an ethoxylated C16 fatty alcohol is on average between 10 and 38 EO units and, for an ethoxylated C8 fatty alcohol, is on average at least 6, more preferably at least 10, and up to 22 EO units per molecule.

The amount of the fatty alcohol component in the foaming agent is preferably at least 5 wt %. The maximum amount of the fatty alcohol component is not more than the amount of the glycol component, and preferably not more than half the concentration of the glycol component.

The glycol component c) includes or consists of an individual glycol or two or more glycols selected from the following group: lower glycols, including alkyl glycols, alkylene glycols, and di-, tri- and polyglycols, preferably having up to 12 carbon atoms per molecule, and more preferably selected from the following group: alkyl glycols and alkylene glycols up to C10 alkyl, diglycols, and diglycol ethers. Particularly preferred examples are propylene glycol, hexylene glycol, butylene glycol, butyl diglycol, diethylene glycol, dipropylene glycol. It is particularly preferred if the mixture comprises or consists of diglycols, triglycols and/or alkyl diglycols. It is currently supposed that the particularly advantageous effect of the last-mentioned group derives from the fact that the chemical similarity of the structural units imparts particularly good miscibility and stability over a wide temperature range.

The glycol component acts as part of the solvent, or as an organic constituent of the aqueous-organic solvent system, and at the same time as a solubilizer for other ingredients, additives and/or admixtures. The glycols serve simultaneously as antifreeze and allow the foaming agent according to the invention to be serviceable even at temperatures below 10° C.

The glycol component is present in the foaming agent preferably in an amount of 10 to 50 wt %.

In further embodiments, the foaming agent may comprise additional additives, more particularly admixtures known from the concrete, lime and gypsum industries, such as fillers, dyes, wetting agents, retardants, accelerators, alkali metal salts, thixotropic agents and/or organic or inorganic acids or bases for pH adjustment.

The additives, or admixtures and auxiliaries, when present at all, are present in a customary additive amount in the foaming agent, in other words at up to 2, 3 or 5 wt %, and the additives together are present in an amount of at most up to 10 wt % of the foaming agent.

Fillers and thixotropic agents—again insofar as they are wanted in the formulation—are frequently required at a higher concentration than other additives. Their amount in total is preferably up to 10 wt %. Examples of fillers and thixotropic agents are Si-based inorganic salts and/or oxides, such as silica and/or orthosilicates.

In the foaming agent, preferably additionally, there may be a polycarboxylate ether as a possible additive. The polycarboxylate ether additive, which is included preferably in an amount of 0.01-12 wt %, based on the total foaming agent weight, more preferably 0.01-5 wt % or 0.01-3 wt %, results in a longer-lasting foam produced from the foaming agent (e.g., water and foaming agent alone), and also of the binder paste foam. Surprisingly, just a very small amount of the polycarboxylate ether is sufficient for this effect. For this purpose it is possible to use the polycarboxylate ethers known as plasticizers from the cement industry.

Specified below is one preferred foaming agent composition according to the invention:

a) 1-5 wt % (solids content) of one or more anionic surfactants,

b) 2-20 wt % of the fatty alcohol component,

c) 10-50 wt % of the glycol component,

d) 0-10 wt % in total of fillers or thixotropic agents,

e) 0-10 wt % in total of further additives, water ad 100 wt %.

With the aid of the above description of the constituents additional exemplary compositions are apparent, preferably within the boundaries indicated.

Prior to use, the foaming agent may be diluted with additional water to up to 25 times its volume. The basis for this is that the foaming agent is preferably offered and transported in the form of a concentrate. It is initially diluted by the user and then foamed to form a foam which is introduced into a binder paste or material to foam and is mixed therewith, before the foamed mixture is allowed to cure.

In an embodiment of the invention it is possible to use the foaming agent in paste form or in powdery solid form, by subjecting the above-described liquid foaming agent to freeze drying or to vacuum evaporation to an extent such that the desired consistency is produced. Drying has advantages for transport. A liquid foaming agent can be regenerated from the dried product at any time.

In particular, a dried foaming agent in powder form (vacuum-dried or freeze-dried) saves considerable transport costs, owing to the lower weight, and therefore delivers valuable additional application advantages.

It is considered a particular advantage of the invention that success has been achieved in providing a foaming agent, especially for hydraulic binder pastes, that consists entirely of ingredients that are available commercially in sufficient quantity, are commonplace for numerous other purposes, and as a result can be acquired at relatively favorable cost.

1. A foaming agent for foaming of a building material/binder paste for producing pory lightweight-construction and insulating materials, the foaming agent being present in a form of an aqueous-organic solution consisting to an extent of at least 85 wt % of the following constituents, and water:
a) a surfactant component which comprises at least one foam-forming ionic surfactant,
b) a fatty alcohol component which comprises at least one fatty alcohol and at least one ethoxylated fatty alcohol, in a FA/FAEO mixing ratio of 95:5 to 0:100,
c) a glycol component which comprises at least one constituent of a group consisting of alkyl glycols, alkylene glycols up to C6 alkyl, diglycols, and diglycol ethers.

2. The foaming agent as claimed in claim 1 wherein the at least one fatty alcohol is a C6-C20 fatty alcohol or a mixture of C6 to C20 fatty alcohols.

3. The foaming agent as claimed in claim 1 wherein the ethoxylated fatty alcohol of the fatty alcohol component is an ethoxylated C6-C24 fatty alcohol having a degree of ethoxylation of at least on average 6 EO units per molecule, or a mixture of the aforesaid ethoxylated fatty alcohols.

4. The foaming agent as claimed in claim 1 wherein the surfactant component comprises at least one anionic surfactant.

5. The foaming agent of claim 4 wherein the at least one anionic surfactant is selected from the group consisting of sulfonic acids, sulfonates, carboxylic acids, carboxylic salts, and mixtures thereof.

6. The foaming agent of claim 4 wherein the at least one anionic surfactant is selected from the group consisting of alpha-olefinsulfonic acids, alpha-olefinsulfonic salts, alkyl sulfates, alkylene sulfates, alkylsulfonates, sulfuric monoester salts, and mixtures thereof

7. The foaming agent as claimed in claim 1 further comprising at least one additive.

8. The foaming agent of claim 7 wherein the at least one additive is selected from the group consisting of fillers, dyes, wetting agents, thixotropic agents, organic or inorganic acids or bases for pH adjustment, and mixtures thereof.

9. The foaming agent as claimed in claim 1 further comprising at least one polycarboxylate ether.

10. The foaming agent of claim 9 wherein the at least one polycarboxylate ether is present in the foaming agent in an amount of 0.01 to 12 wt %.

11. The foaming agent of claim 9 wherein the at least one polycarboxylate ether is present in the foaming agent in an amount of 0.01 to 5 wt %.

12. The foaming agent, comprising or consisting of:
a) 1-5 wt % (solids content) of one or more anionic surfactants,
b) 2-20 wt % of the fatty alcohol component,
c) 10-50 wt % of the glycol component,
d) 0-10 wt % in total of fillers or thixotropic agents,
e) 0-10 wt % in total of further additives, water ad 100 wt %.

13. The foaming agent as claimed in claim 12 further comprising additional water diluting the foaming agent to up to 25 times an initial volume without the additional water.

14. A foaming agent in paste or powdery-solid form, obtainable by freeze drying or vacuum evaporation from a foaming agent as claimed in claim 12.

15. A lightweight porous construction product or element, obtainable using a binder paste foamed with the foaming agent as claimed in claim 1.

16. The lightweight porous construction product or element as claimed in claim 15, wherein the binder paste is a cement paste or a gypsum paste.
